(19) United States
(12) Patent Application Publication
(10) Pub. No.: US 2013/0341187 A1
(43) Pub. Date: Dec. 26, 2013

(54) MEASUREMENT DEVICE FOR DETERMINING A PROCESS VARIABLE

(71) Applicant: KROHNE Messtechnik GmbH, Duisburg (DE)

(72) Inventor: Christine BABEL, Weil der Stadt (DE)

(21) Appl. No.: 13/660,103

(22) Filed: Oct. 25, 2012

(30) Foreign Application Priority Data
Jun. 26, 2012 (DE) 10 2012 012 528.3

(51) Int. Cl. G01N 27/416

(52) U.S. Cl. CPC G01N 27/4166
USPC 204/406

(57) ABSTRACT

A measurement device (1) for determining a process variable with a sensor element (2) and a circuit board (3) in which the arrangement of the components, and especially of at least one circuit board, is protected against the effects of potting by the measurement device having a retaining element (5) which is made essentially as a cylindrical pin and is in contact with a side of the circuit board (3) facing away from the sensor element (2), the circuit board (3) being fixed between the sensor element (2) and the retaining element (5).

### BACKGROUND OF THE INVENTION

1. Field of the Invention

The invention relates to a measurement device for determining at least one process variable with at least one sensor element for measuring the process variable and with at least one circuit board, the sensor element being connected directly or indirectly to the circuit board and/or to at least one component located on the circuit board.

2. Description of Related Art

In modern process and automation engineering, to monitor and determine process variables, measurement devices are used which generate a measured quantity which is dependent on the process variable which is to be measured. The measured quantity is generally an electrical signal which is accessible to evaluation and further processing. The process variables are, for example, the flow rate, the pH value, the liquid level or the temperature of a medium.

These measurement devices of the prior art generally have at least one sensor element which generally comes into contact or interacts with a process medium, and downstream electronics which optionally control the measurement of the sensor unit or evaluate or further processes the measurement signals of the sensor unit. Part of the electronics is generally at least one circuit board which bears the components. It can be a rigid or also a flexible circuit board. Circuit boards, here, are generally defined as carriers of electronic components.

For the structure of the measurement device, preferably, a modular design is used so that the same components or modules can be used in manufacturing according to the modular principle for differently configured or dimensioned measurement devices. Optionally, also sections of a housing which surround the components are provided on the inside with a metal coating for shielding (see, for example, German Patent Application DE 10 2010 039 063 A1 and corresponding U.S. Patent Application Publication 2012/0031662 A1).

In order to avoid leakage problems and to produce insulations, the devices are conventionally potted with a potting compound (see, for example, German Patent Application DE 10 2007 008 074 A1 or DE 10 2009 060 872 A1). The potting is associated with known problems. Thus, not only access for the potting, but also escape possibilities for the air are necessary. The arrangement of the components, in particular, must make it possible for the potting to be able to penetrate into the cavities which are to be sealed. Furthermore, the process can last a very long time depending on the viscosity of the potting compound. Moreover, as a result of the flow of the potting during potting itself or for the already potted measurement device, it can happen that components or even complete circuit boards are moved or shifted as a result of temperature-dependent expansion movements of the potting.

### SUMMARY OF THE INVENTION

Therefore, a primary object of the invention is to provide a measurement device in which the arrangement of the components, and especially of at least one circuit board, is protected against the effects of potting.

This object is achieved, first of all, essentially in the measurement device under consideration, in that there is at least one retaining element which is made essentially as a cylindrical pin. Here, the retaining element is in contact with a side of the circuit board facing away from the sensor element, the circuit board being fixed between the sensor element and the retaining element. The circuit board is held, in accordance with the invention, by a retaining element, especially in the form of a cylindrical pin, and thus, is also preferably clamped relative to the sensor element. The cross section of the retaining element, in one version, is made as a cylindrical pin that is circular in one configuration and polygonal in an alternative version. For fixing, the retaining element, in one configuration, has a recess for accommodating a section of the circuit board on one end. The recess in one version is a groove in the retaining element whose width is at least equal to the thickness of the circuit board at the site which is made in the recess. In an alternative or supplementary configuration, the circuit board has a recess into which the retaining element is introduced. If both the retaining element and also the circuit board have recesses, in this way, there is further protection against tilting of the circuit board in the measurement device. The retaining element is accommodated, in one configuration, with its end facing away from the circuit board in a component which is used, in turn, for fixing and fastening, and thus, holding of the retaining element.

According to one preferred configuration of the invention, the circuit board has an opposing recess in the engagement region with the retaining element so that the circuit board and the retaining element engage one another, which results in that the retaining element fixes the circuit board essentially in three special dimensions.

According to one configuration, there is at least one housing which at least partially encompasses at least the circuit board, the retaining element and the sensor element. The sensor element, for example, projects partially out of the housing or is connected to a window within the housing. In one configuration, the circuit board and the retaining element are completely surrounded by the housing. In one configuration, on the inside wall of the housing, there is a metal coating for an electromagnetic shield.

In one configuration, the sensor element is used to measure the pH and/or the chlorine content and/or the oxygen content and/or the electrical conductivity and/or the disinfection parameters and/or the turbidity. Alternative process variables are, for example, the flow rate, temperature, oxygen content, chlorine content, redox potential or liquid level.

Especially for the configuration—but not necessarily only for it—that the housing is at least partially potted, the following configurations are advantageous. The following configurations also allow implementation as a measurement device and do not have the retaining element which is described above.

In one configuration, there is at least one sleeve which is located in the housing and/or partially forms the housing. The sleeve which is made, in one configuration, especially rotationally symmetrical or especially as a hollow cylinder, on its inner wall has at least two depressions and at least partially encompasses the sensor element, or conversely the sensor element is located at least partially in the sleeve. Here, the sleeve and the sensor element are configured and matched to one another such that at least the sleeve and the sensor element form at least one space at least on the end of the sleeve facing away from the circuit board, between the sensor element and the sleeve, at least in the region of the at least two depressions. Between the sleeve and the sensor element, there is at least one—optionally, also subdivided into at least two component spaces—space through which especially the potting can be introduced, for example, via a hollow needle, and through which the air can escape during potting. After potting, this intermediate space is also preferably filled with potting. In one configuration, the sleeve and the sensor element touch one another at least in sections or the sensor element is held in its position by regions of the sleeve.

In order to be able to insert the aforementioned hollow needle and at the same time not to make the space for the escaping air too large, in one configuration, the two depressions delineate different cross sectional areas, in one configuration the smaller cross section areas being used for escape of the air and the larger cross sectional area being used for delivering the potting. A larger delivery surface for the potting has the advantage that the potting time is reduced or that potting with a higher viscosity can be used. In another configuration, there are still additional depressions for the air. Here, in one configuration with several depressions in the inner wall, it is provided that the depressions delineate essentially semicircular cross sectional areas. In one configuration, this leads especially to the sleeve, at least on the end facing away from the circuit board, therefore, the end which faces the sensor unit, being made essentially rosette-shaped. The cross-sectional areas are viewed perpendicular to a longitudinal axis of the sleeve. In this connection there is another configuration in which at least two—or more depending on the configuration—depressions run at least in sections axially essentially parallel to a longitudinal axis of the sleeve. In one configuration, the depressions axially adjoin a larger clearance. Regardless of the special configuration, the depressions are generally accessible from the end of the sleeve facing away from the circuit board. Optionally, on the edge, first of all, there is a shoulder or a bevel. In one configuration, at least the sleeve and the circuit board, especially after potting, form a compact unit which is suitably connected to the other components and especially to the sensor element in the installation of the measurement device.

In a supplementary configuration which can be implemented in part in conjunction with individual ones of the aforementioned configurations and which relates quite generally to a measurement device for determining at least one process variable with at least one sensor element for measurement of the process variable and with at least one circuit board, the sensor element being directly or indirectly connected to the circuit board and/or to at least one component located on the circuit board, there is at least one plug core, especially on the end of the measurement device opposite the sensor element. The plug core guides at least one electrical contact or several electrical contacts, for example, in the form of wires, and is thus used to feed or extract signals or electrical power or enables in general the connection of the measurement device to the measurement engineering environment. At least one of the contacts guided in the core is in contact with the side of the circuit board facing away from the sensor element (for example, via at least one solder connection) and therefore, fixes the circuit board which is configured, and accordingly, geometrically matched. Therefore, in this configuration, the retaining element can be omitted. For this purpose, the further geometry of the measurement device should also be considered and should be adapted accordingly. Accordingly, this configuration can optionally also be viewed preferably in conjunction only with the partially rosette-shaped sleeve.

In particular, there is a plurality of possibilities for embodying and developing the measurement device in accordance with the invention. In this respect reference is made to the following description of exemplary embodiments in conjunction with the accompanying drawings.

### BRIEF DESCRIPTION OF THE DRAWINGS

FIG. 1 is a schematic cross-sectional view of a measurement device which illustrates essentially the functional active relationships,

FIG. 2 is a perspective view of the retaining element of the measurement device of FIG. 1,

FIG. 3 is a plan view of the end of the sleeve of the measurement device of FIG. 1, which end faces the process,

FIG. 4 is a sectional view through the sleeve of FIG. 3,

FIG. 5 is a perspective view of the sleeve of FIGS. 3 & 4, and

FIG. 6 is s a schematic sectional view of an alternative configuration of a measurement device.

### DETAILED DESCRIPTION OF THE INVENTION

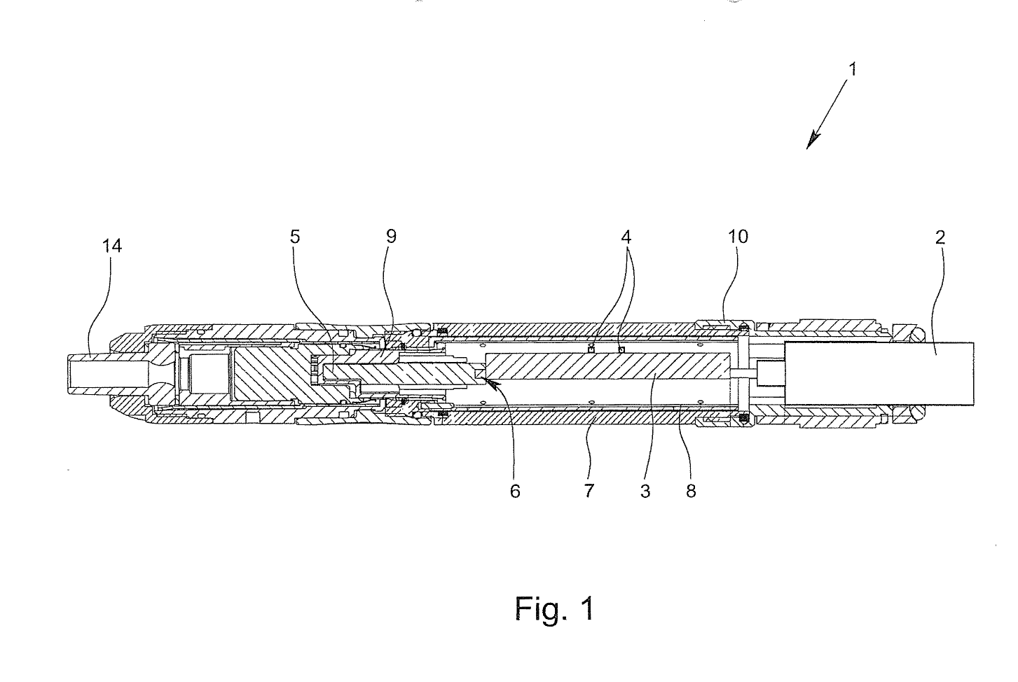

FIG. 1 shows a section through a measurement device 1 in accordance with the invention, in the illustrated example, the device 1 being used especially to measure the pH. For this reason a sensor element 2 is made accordingly as a glass body or alternatively from a plastic. The sensor element 2 is bordered by a circuit board 3 on which the components 4 which are necessary for the processing of the signals of the sensor element 2 or for its control are located.

For the process of potting and for holding the circuit board 3, there is the retaining element 5 which is made especially essentially as a circular cylindrical pin or rod. The circuit board 3 with one end (which is preferably made for connection to the retaining element 5, for example, is thinned) rests in a recess 6 in the form of a groove in the end region of the retaining element 5. The retaining element 5 also has the advantage that another sleeve, which could optionally be used for holding the circuit board 3 is not critically necessary, but that the circuit board 3 can be located directly in the housing 7 without further jacketing.

Only the inner wall of the housing 7 is provided with a metal coating 8 for electromagnetic shielding.

Tilting of the circuit board 3 during potting so as to cause the components 4 or a line come into contact with the wall is prevented here by the retaining element 5. With its end away from the circuit board 3, the retaining element 5, which is especially made solid from steel plugs, plugs in an insulation element 9 which is held, in turn, laterally in the housing 7. Thus, altogether, the circuit board 3 is fixed, and preferably also braced, between the holding element 5 and the sensor element 2 so that any tilting thereof can be avoided. The connection between the sensor element 2 and the circuit board 3 is implemented especially via solder contacts or plug-in contacts or via corresponding adapter units. In particular, after potting, a partial unit is formed which is closed in itself and which can be connected to the sensor element 2 or can make contact with it. In other configurations, the retaining element is made of plastic. The connection for transmission of signals and electrical power between the measurement device 2 and the surrounding equipment takes place especially via the plug core 14 which guides the electrical contacts, for example, wires or electrical lines.

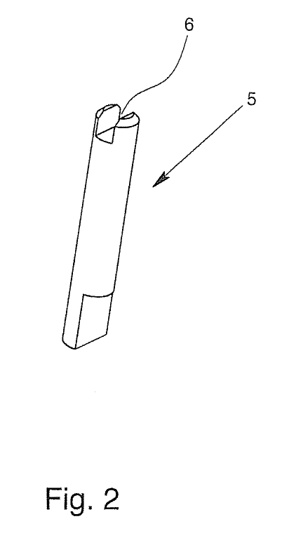

The retaining element 5 is shown in FIG. 2. The recess 6 in one end which holds and fixes the circuit board 3 can be clearly recognized. The other end has a flattened region which is used for introduction into the insulation element 9 as a holder of the retaining element 5. The retaining element 5 is preferably formed from a rigid steel cylinder.

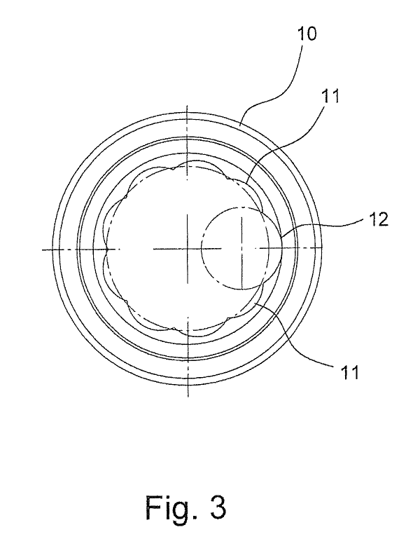

The sensor element 2 is surrounded by a sleeve 10 which, in the illustrated configuration of FIG. 1, also forms the end of the measurement device 1 facing the process. The sleeve 10 is shown more exactly in FIGS. 3 to 5.

The view of the end of the sleeve 10 of FIG. 3 facing the process shows the depressions 11, 12 which altogether yield a rosette shape. Furthermore, it can be recognized that a depression 12 encompasses a larger cross sectional area than the other depressions 11. During production of the measurement device, the potting mass is introduced via this larger depression 12 using a hollow needle and air can escape via the other depressions 11. At the same time, the board rests on the sections of the inner wall of the sleeve 10 in the installed state.

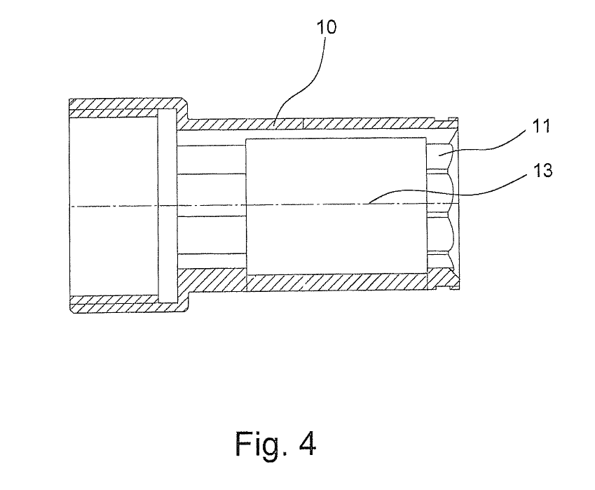

FIG. 4 shows a section of the inner wall of the sleeve 10. The depressions 11 extend only over a limited section along the longitudinal axis 13 of the sleeve 10 and then discharge in a larger-area recess which is adjoined in turn by further depressions in the axial direction. Between the depressions 11 there are bridges which, in the installed state, make contact with the sensor element, and thus, hold it. The depressions 11 especially make it possible to pot the sleeve 10 also from the side facing the process. Here, especially the sleeve 10, the sensor element 2, and optionally, also the circuit board 3 can be combined into a single component which is already potted and which then is combined with the other components and elements to form a complete measurement device. In one alternative version, at least the sleeve 10 and the circuit board 3, after potting, form an independent unit which preferably has corresponding contact elements, for example, plugs or lines to the outside, and which is combined appropriately, in particular, with the sensor element 2 when the measurement device is assembled.

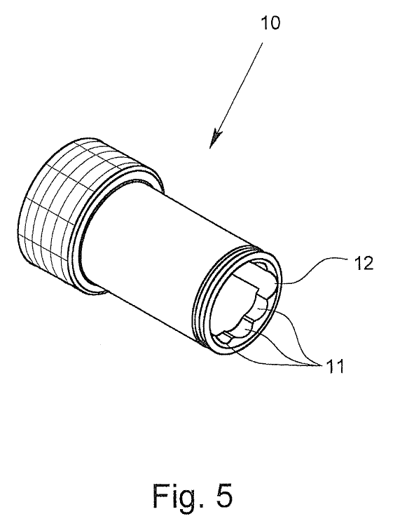

The three-dimensional representation of FIG. 5 of the sleeve 10 shows, on the one hand, a much larger depression 12 for the introduction of the potting mass, in contrast to the smaller depressions 11 for the escape of air. On the end which is the lower one here, the knurling of the sleeve 10 can be recognized which partially yields the outer configuration of the measurement device 1. In one alternative configuration (not shown), there are two larger depressions 12 in order to have several possibilities optionally for simultaneous or symmetrical introduction of a potting mass. Thus, in particular, advantages arise in the automation of the production of the measurement device.

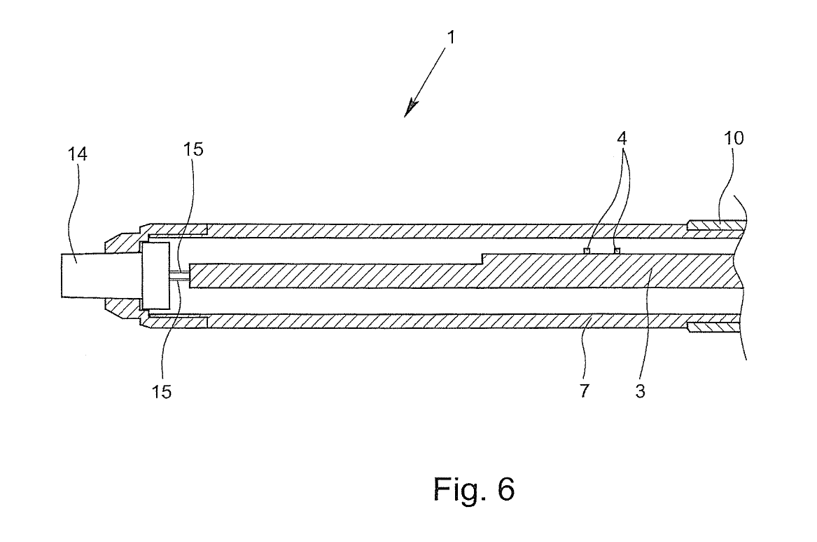

FIG. 6 shows a measurement device 1 in which the circuit board 3 is directly connected to the plug core 14 of the measurement device 1. Here, there are two contacts 15 which are guided into the core 14, soldered to the circuit board 3, and thus, fix the circuit board 3 against tipping. Therefore, the retaining element 5 can be omitted by this direct connection between the circuit board 3 and core 14 via the contacts 15.

What is claimed is:

1. A measurement device for determining at least one process variable, comprising:
at least one sensor element for measuring the process variable,
at least one circuit board, and
at least one retaining element which is made essentially as a cylindrical pin,
wherein the at least one sensor element is connected to at least one of at least one the circuit board and at least one component located on the at least one circuit board,
wherein the at least one retaining element is in contact with a side of the at least one circuit board that is facing away from the at least one sensor element, and
wherein the at least one circuit board is fixed between the at least one sensor element and the at least one retaining element.

2. The measurement device in accordance with claim 1, wherein the at least one retaining element has a recess on one end for accommodating a section of the at least one circuit board.

3. The measurement device in accordance with claim 1, further comprising at least one housing which at least partially encompasses at least the at least one circuit board, the at least one retaining element and the at least one sensor element.

4. The measurement device in accordance with claim 3, wherein a metal coating for an electromagnetic shield is provided on an inside wall the at least one housing.

5. The measurement device in accordance with claim 1, wherein the at least one sensor element is adapted for measuring at least one of pH, chlorine content, oxygen content, electrical conductivity, disinfection parameters, and turbidity.

6. The measurement device, comprising,
at least one sensor element for measuring the process variable,
at least one circuit board,
at least one retaining element which is made essentially as a cylindrical pin,
at least one housing which at least partially encompasses at least the at least one circuit board, the at least one retaining element and the at least one sensor element, and
at least one sleeve which is located in the housing or which partially forms the housing,
wherein the at least one sensor element is connected to at least one of at least one the circuit board and at least one component located on the at least one circuit board,
wherein the at least one retaining element is in contact with a side of the at least one circuit board that is facing away from the at least one sensor element, and
wherein the at least one circuit board is fixed between the at least one sensor element and the at least one retaining element
wherein an inner wall of the sleeve has at least two depressions,
wherein the sleeve at least partially encompasses the sensor element, and
wherein the sleeve and the sensor element are configured and matched to one another such that at least the sleeve and the sensor element, at least on an end of the sleeve facing away from the circuit board form at least one space between the sensor element and the sleeve at least in a region of the at least two depressions.

7. The measurement device in accordance with claim 6, wherein the two at least two depressions comprise depressions of different cross sectional areas.

8. The measurement device in accordance with claim 6, wherein the at least two depressions have essentially semicircular cross-sectional areas.

9. The measurement device in accordance with claim 8, wherein the sleeve, at least on the end facing away from the circuit board is essentially rosette-shaped.

10. The measurement device in accordance with claim 6, wherein at the least two depressions run, at least in sections, axially essentially parallel to a longitudinal axis of the sleeve.

11. The measurement device in accordance with claim 6, further comprising at least one plug core , wherein at least one electrical contact is guided in the plug core, and wherein at least one contact is in contact with the side of the circuit board facing away from the sensor element.
